(19) United States
(12) Patent Application Publication
(10) Pub. No.: US 2017/0056283 A1
(43) Pub. Date: Mar. 2, 2017

(54) Physical therapeutic assemblies and methods for providing physical therapy

(71) Applicant: Jacob Baumann, Post Falls, ID (US)

(72) Inventor: Jacob Baumann, Post Falls, ID (US)

(21) Appl. No.: 15/330,768

(22) Filed: Nov. 5, 2016

Related U.S. Application Data
(60) Provisional application No. 62/253,555, filed on Nov. 10, 2015.

(51) Int. Cl. A61H 15/00

(52) U.S. Cl. CPC A61H 15/00; A61H 2015/0064

(57) ABSTRACT

The present invention relates to a physical therapy machine or assembly and method which is used in the application of treatments to relieve mayofascial pain syndrome. The invention comprises spheres, arrangeable mounting stations, and a base platform.

### TECHNICAL FIELD

The present invention relates to physical therapy assemblies and methods for providing physical therapy.

### BACKGROUND

Myofascial release is a method that has been used by physical therapists to provide physical therapy. Two forms of myofascial release have been utilized; direct myofascial release and self myofascial release techniques. The benefits of myofascial release have been recognized by physical therapists. Many tools have been used by physical therapists to provide myofascial release.

These tools include rollers, foam rollers, quad rollers, rumble rollers, balls, golf balls, tennis balls, lacrosse balls, softballs, medicine balls, as well as the physical therapist's own or the actual patient's own hands. Other members include the theracane or the knobbler, as well as the stick & tiger tail.

Many of these techniques and/or apparatuses have disadvantages. For example, it can be difficult for the patient to apply or have applied, these techniques to them when their muscles are not in a relaxed manner. With regard to the foam roller, for example, when self-applying the foam roller technique, at least part of the patient's torso is tense, which can result in neck or shoulder pain. The current tools that are available regrettably only provide unilateral application, rather than bilateral to balance between right and left hand sides of the body. Further, these techniques typically have a lack of symmetry and precise positioning of the patient on the apparatus. The present disclosure provides assemblies and methods that can overcome the disadvantages of the prior art assemblies and methods.

### DRAWINGS

Embodiments of the disclosure are described below with reference to the following accompanying drawings.

FIG. 1A is a patient and assembly according to methods and an embodiment of the disclosure.

FIG. 1B is another depiction of the patient and assembly of FIG. 1A showing at least one direction of movement of the patient upon the assembly according to an embodiment of the disclosure.

FIG. 2 demonstrates another patient and assembly of the disclosure and demonstrates the patient being able to move in at least bidirectional if not multidirectional fashion.

FIGS. 3A and 3B depict an assembly according to an embodiment of the disclosure.

FIGS. 4A and 4B depict individual contact points of an assembly according to an embodiment of the disclosure.

FIGS. 5A-5C depict configurations of the assembly with contact points arranged in specific configurations.

FIG. 6 depicts an assembly according to an embodiment of the disclosure.

FIG. 7 is another view of the assembly of FIG. 6 according to an embodiment of the disclosure.

FIG. 8 is another view of the assembly of FIG. 6 according to an embodiment of the disclosure.

FIG. 9 is another view of the assembly of FIG. 6 according to an embodiment of the disclosure.

FIGS. 10-12 are different view of the assembly of FIG. 6 according to an embodiment of the disclosure.

FIG. 13 is a view of a portion of the assembly of FIG. 6 according to an embodiment of the disclosure.

FIGS. 14-15 are views of portions of the assembly of FIG. 6 according to an embodiment of the disclosure.

FIG. 16 is a view of another assembly according to another embodiment of the disclosure.

FIG. 17 is a view of the assembly of FIG. 16 according to an embodiment of the disclosure.

FIG. 18 is a view of the portion of the assembly of FIG. 16 according to an embodiment of the disclosure.

FIG. 19 is a view of a configuration of the assembly of FIG. 16 according to an embodiment of the disclosure.

FIG. 20 is another view of a configuration of the assembly of FIG. 16 according to an embodiment of the disclosure.

### DESCRIPTION

This disclosure is submitted in furtherance of the constitutional purposes of the U.S. Patent Laws “to promote the progress of science and useful arts” (Article 1, Section 8).

The present disclosure provides a board like member with variable pressure or contact points (e.g., balls or wheels) arranged such as evenly spaced in a grid-like pattern. For example, direct pressure can be applied to both halves of the body of the patient at the same time, which can provide even correction of restricted myofascial tissue. The amount of pressure can be adjusted by the participant, by switching out the roller balls or wheels for small ones as desired. Effective myofascial release can be performed in a relaxed position.

The assembly and methods of the present disclosure can accomplish this by allowing the individual patient to comfortably relax on a substrate such as a carpet or bed with another substrate, such as a pillow, to support their head, neck, and/or shoulders. One of the features of the present apparatus and method is the precise arrangement/placement of the balls and/or rollers on the assembly. The apparatus and methods can provide intersecting pressure points located at intervals such as one inch, intervals that can cross somewhere on the assembly to accommodate every patient body type, from small children to large adults. In accordance with example implementations, the apparatus can have balls or wheels evenly spaced in a grid-like pattern.

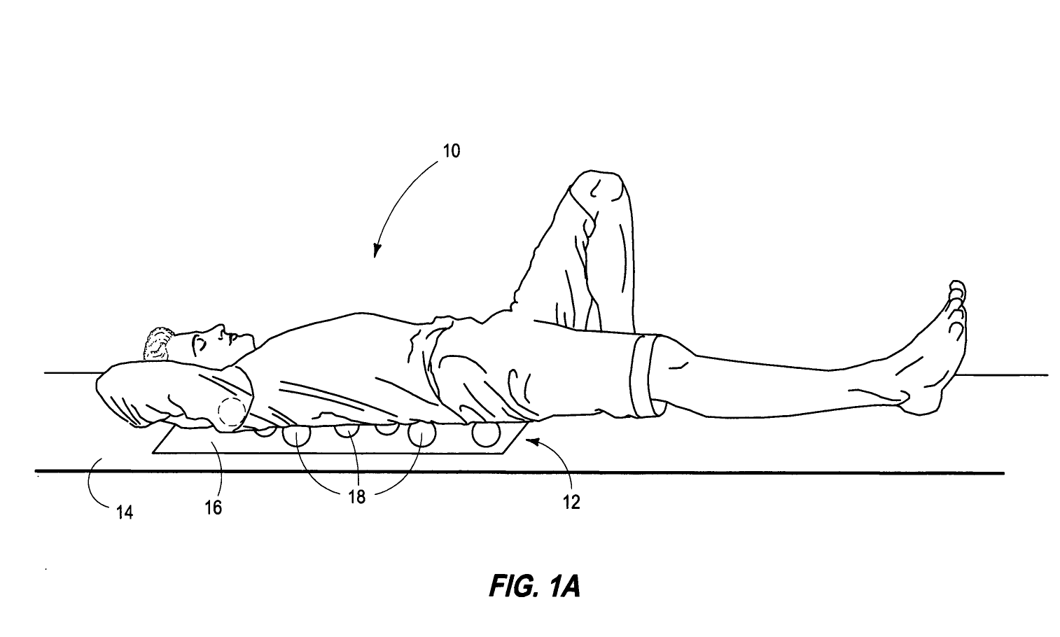

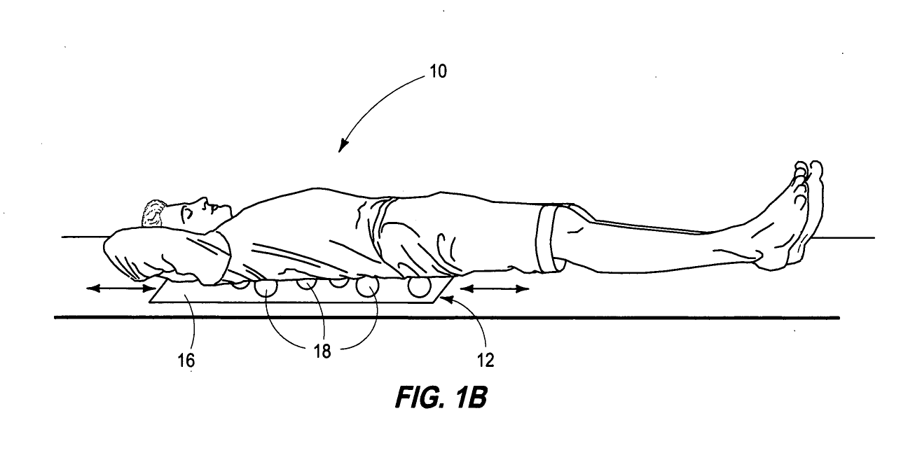

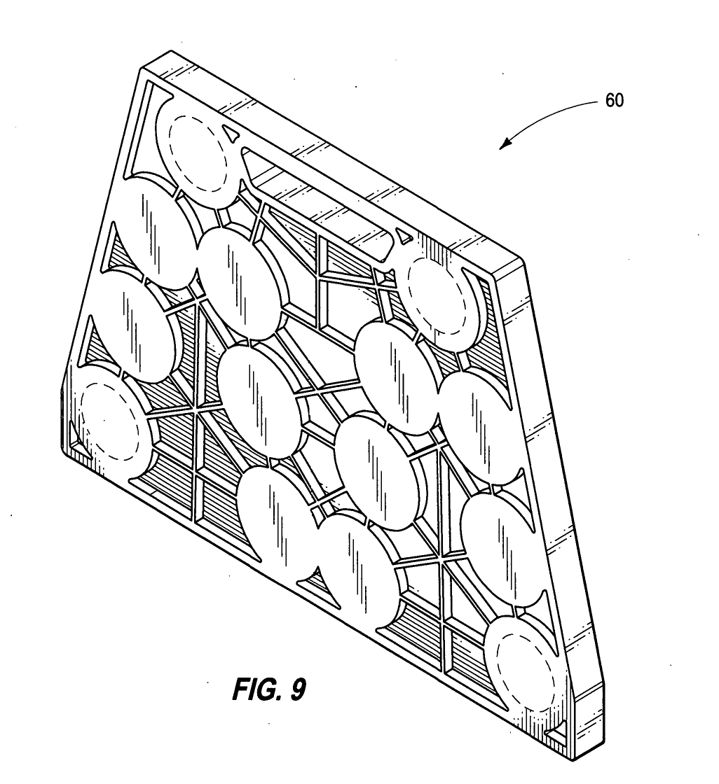

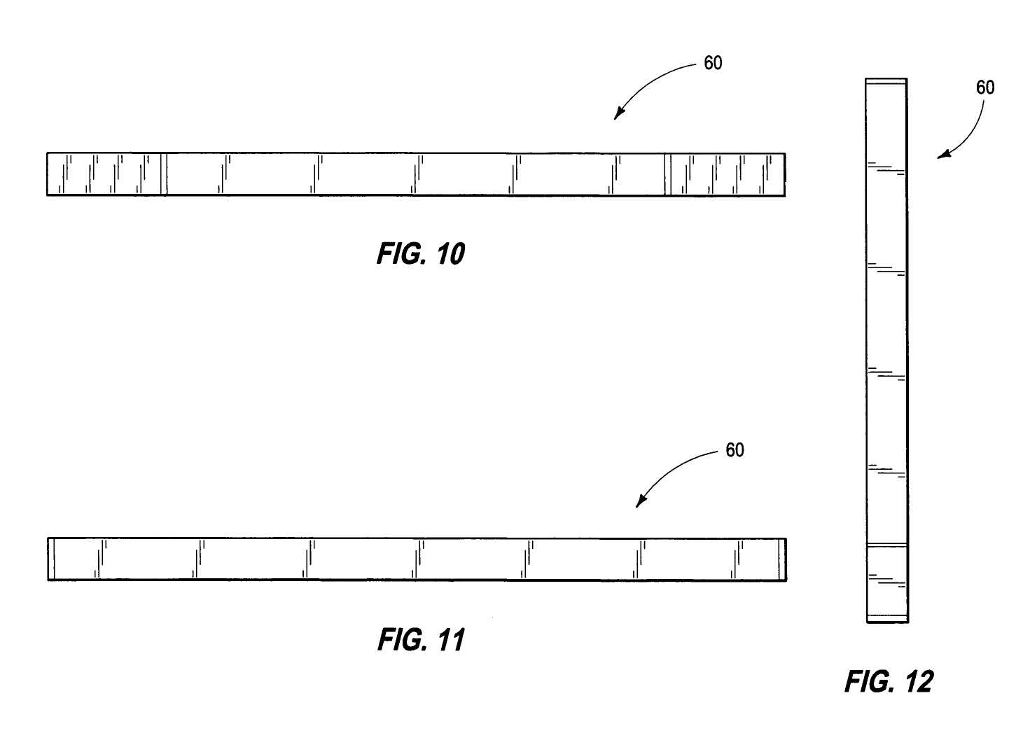

The methods and assemblies of the present disclosure will be described with reference to FIGS. 1A-20. Referring first to FIG. 1A, a patient 10 is shown in a supine position above an apparatus 12, which is also supported by a substrate 14. The patient can be in a supine or prone position, as well as lateral or either lateral side-down positions. The positioning of the patient can be dictated by the therapist and/or the instructions for providing physical therapy, for example. Substrate 14 can be any substrate; it may be a bed, it may be a floor or carpeted flooring for example. Typical substrates include that which can support apparatus 12.

Apparatus 12 can include a substrate 16 such as a board and a plurality of rotating members 18, such as balls, that can rotate as much as 360° in all directions when placed in board 16. The placement of members 18 within board 16 can be dictated by openings and/or connection coupling points within board 16. Members 18 can be configured to be embraced by at least one plane of the substrate. Each of the plurality of members can be configured to contact the patient and rotate allowing the patient to 360 degrees about the plane of substrate 16, for example.

Referring next to FIG. 1B, patient 10 is shown with directional arrows moving back and forth upon apparatus 12, which includes board 16 and members 18. In this implementation, the members 18 can allow for pressure to be provided at specific points aligned within board 16, at the same time utilizing a relaxed body weight upon apparatus 12.

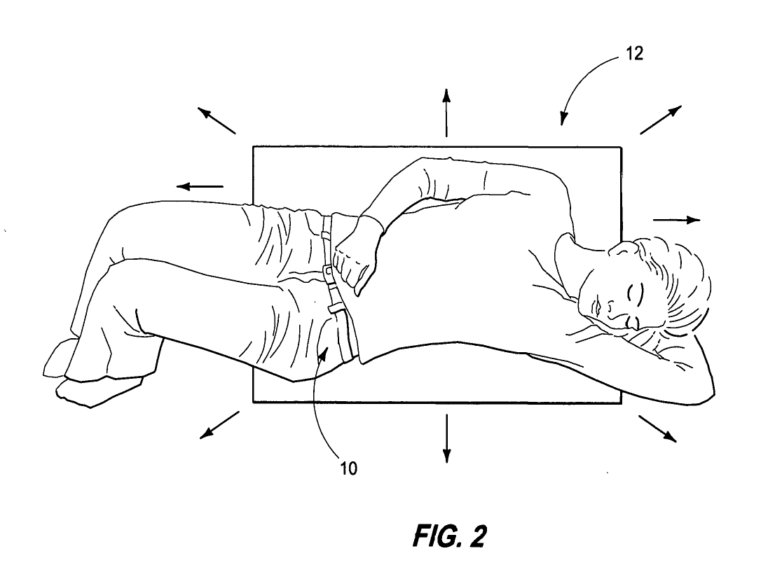

Referring next to FIG. 2, patient 10 is shown above apparatus 12 with directional arrows demonstrating the movement of patient 10 in relation to apparatus 12 in multiple directions; at least laterally as well as headlong or even footlong, as well as other directions contemplated in FIG. 2. As shown, the members 18 within board 16 facilitate this movement by being freely rotatable within board 16.

In accordance with example implementations, assembly 12 can be provided and a patient provided upon the contact points extending from the plane of the substrate. The patient can move and/or be moved (e.g., with caregiver assistance) in relation to the substrate to provide myofascial release, with the contact points rotating upon the moving the patient. At least a portion of the patient can be provided upon the assembly with portion including an extremity and/or trunk for example. As shown, the dorsum is provided.

The patient can be moved in relation to the substrate for example by extending the patient toward one perimeter portion of the substrate and returning the patient from the one perimeter portion. After the returning the patient, the patient can be extended to another perimeter portion and the patient returned the other perimeter portion.

While moving the patient, the contact points can rotate in at least two dimensions, with one dimension being parallel to the plane of the substrate and another dimension being substantially normal to the plane of the substrate. The moving the patient in relation to the substrate can rotate the contact points in at least one of the two dimensions and/or both dimensions.

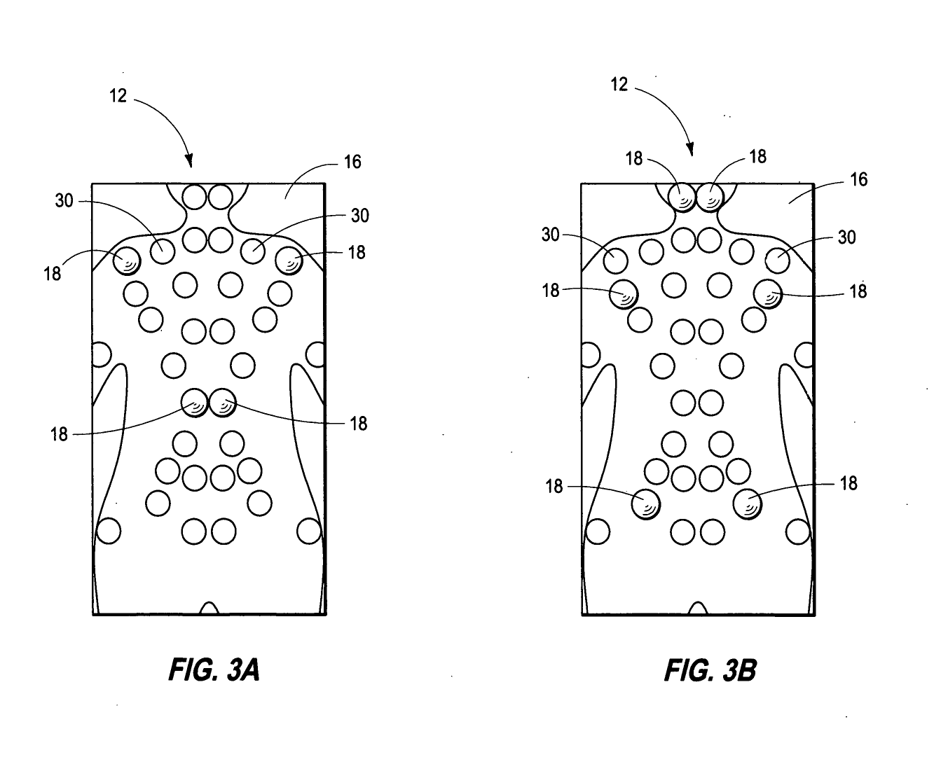

Referring next to FIGS. 3A and 3B, boards 12 are shown in different configurations 3A and 3B. In accordance with one configuration shown in FIG. 3A, members 18 are shown placed in specific openings 30 that are aligned in relation to a body outline placed on board 16. These specific locations can be utilized to treat specific muscles and/or skeletal structures of a patient as prescribed and/or performed by a therapist. In accordance with the example shown in FIG. 3A, the members 18 may be placed to focus on shoulder muscles as well as lower back muscles. In accordance with example configurations and as shown in FIG. 3B, the placement of members 18 within openings 30 can be utilized to focus on neck, different shoulder muscles, and/or different lower back muscles. These openings and configurations of the members within the board can be designed by the physical therapist. However, as shown in FIGS. 3A and 3B, an embodiment of the disclosure provides a design of these openings within the board 16.

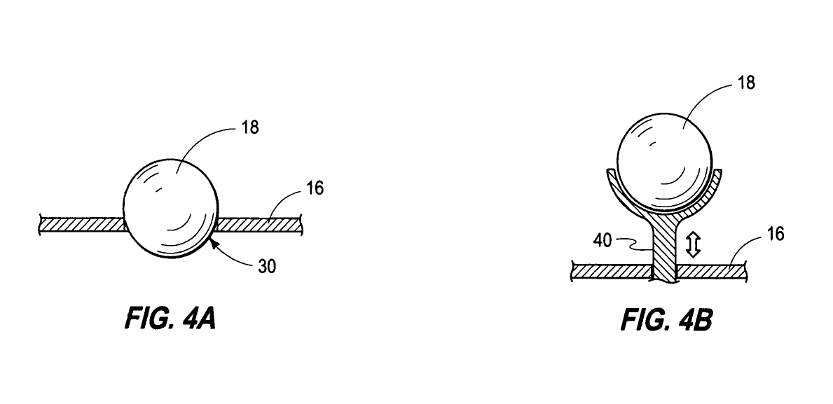

Referring next to FIGS. 4A and 4B, different implementations of the relation of member 18 coupled to board 16 are shown. Referring first to FIG. 4A, an opening 30 is shown within board 16, and member 18 rests within that opening 30. As can be seen, the opening 30 does not have an opening sufficient to allow member 18 to pass all the way there through, but supports member 18, allowing member 18 to rotate freely within opening 30. Referring to FIG. 4B, member 18 may be placed in a pedestal 40 that may be adjustable in relation to board 16. Pedestal 40 can include a screw type arrangement and/or vice type arrangement that allows for the pedestal to be raised or lowered in relation to board 16. As can be seen, this pedestal can include a cup configured to support member 18.

The members 18 of the present disclosure can include spheres and/or like members that may have different pliabilities; pliabilities ranging from extraordinarily hard or unpliable to semi-soft or completely pliable. In accordance with example implementations, the range of these members can be from as hard as billiard balls to as soft as tennis balls and/or racquet balls or handballs. Of importance is the ability of member 18 to rotate freely in relation to board 16.

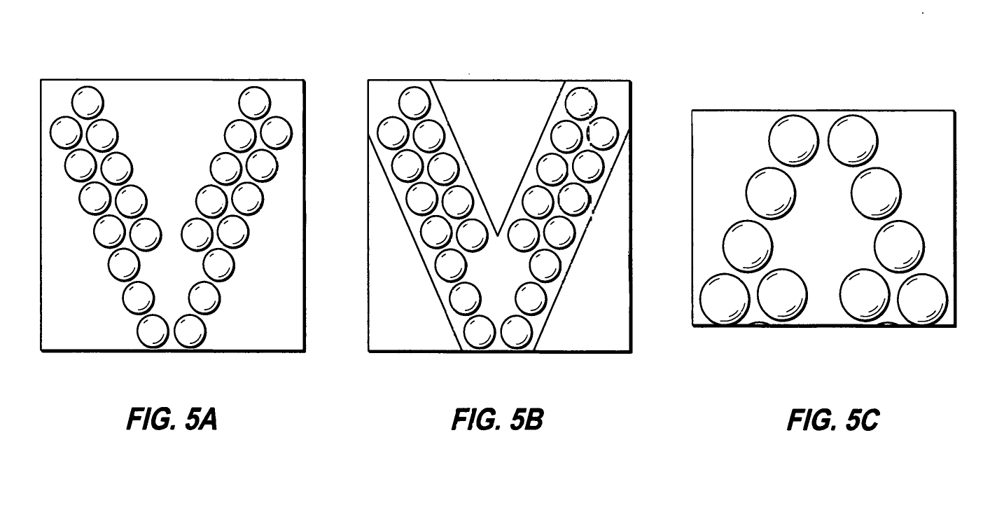

Referring to FIGS. 5A-5C, example configurations of members 18 about board 16 are shown. As can be seen these configurations define a “V” shape which may be utilized in an orientation about board 16 with the narrow portion of the “V” associated with a narrow edge of board 16, and the opposing wide portion of the “V” associated with the opposing narrow edge of board 16, the height of the “V” extending along the length of board 16. Extending patients along the height of the “V” and returning them can provide myofascial release.

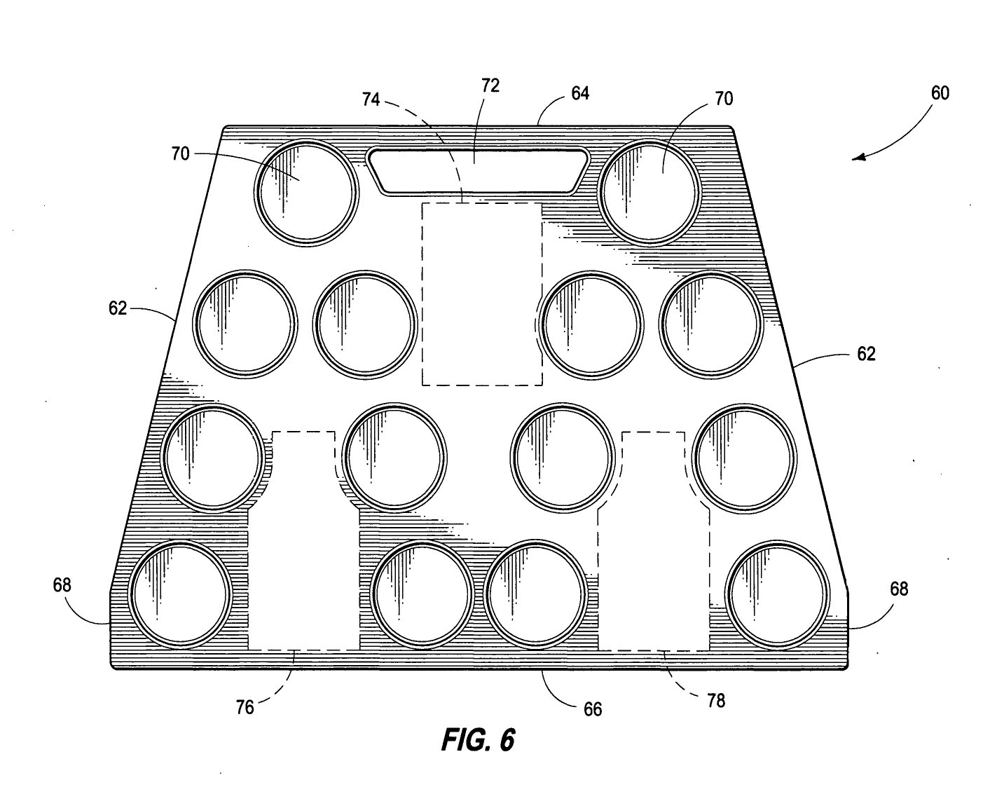

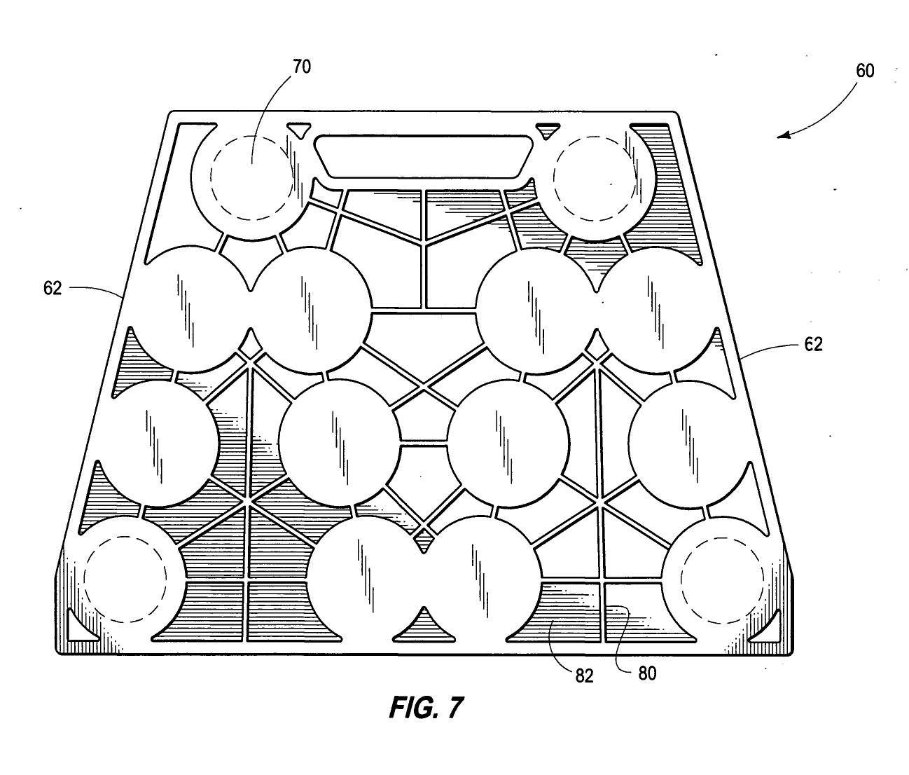

In accordance with an alternative embodiment of the disclosure, assembly 60 of FIG. 6 is shown. This assembly is shown and depicted in FIGS. 7-15 as well. In accordance with example embodiments, assembly 60 can be configured as a board that has opposing transverse parallel side 62 and connected to opposing parallel side 68 which define a perimeter as connected to opposing sides 66 and 64. As can be seen, side 64 is substantially shorter than side 66, and side 68 oppose extending from the longer side 66, giving the assembly 60 a semi-trapezoidal appearance. Assembly 60 can include openings 70 configured to receive balls such as myoballs depicted herein. These openings 70 can be configured to receive these balls and allow for rotation of these balls when pressure is applied transversely. In accordance with example configurations, assembly 60 can include a through handle 72 as well as instruction portions 74, 76, and 78 which will be discussed in detail further. Assembly 60 can have an alignment of opening 70 as shown with portion parallel side 62 in close proximity while also parallel side 62 in opposing proximity.

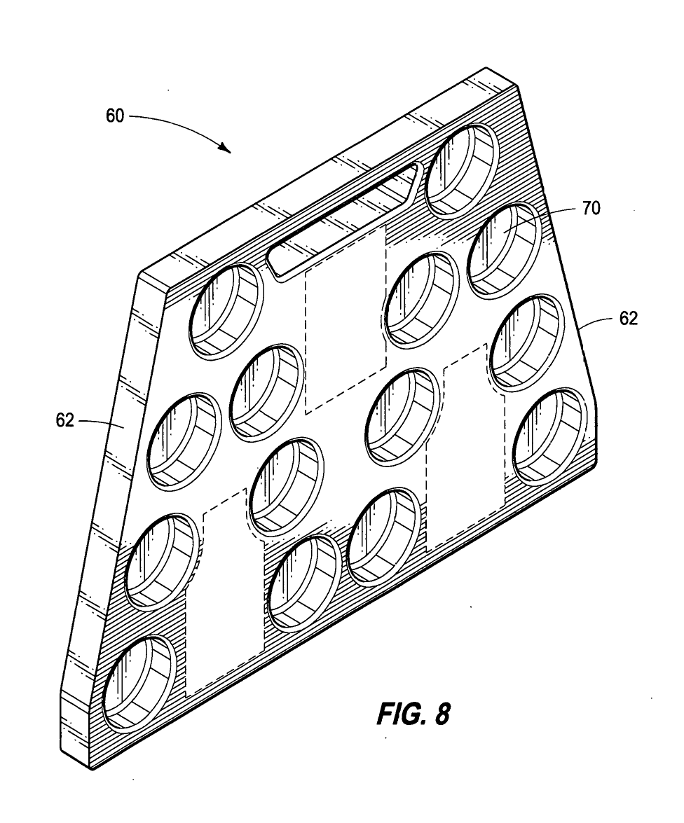

In accordance with example implementations, and with reference to FIG. 7, the rear side of assembly 60 is shown. As shown, assembly 60 can be constructed of a polymer framed material with support structures or members 80 extending to and between and forming open spaces 82. In this configuration, the assembly 60 can be constructed of less polymer, and thereby be insubstantial in weight. With reference to FIGS. 8-12, views of assembly 60 are shown in isometric as well as side views. These views in toto constitute a design of assembly 60.

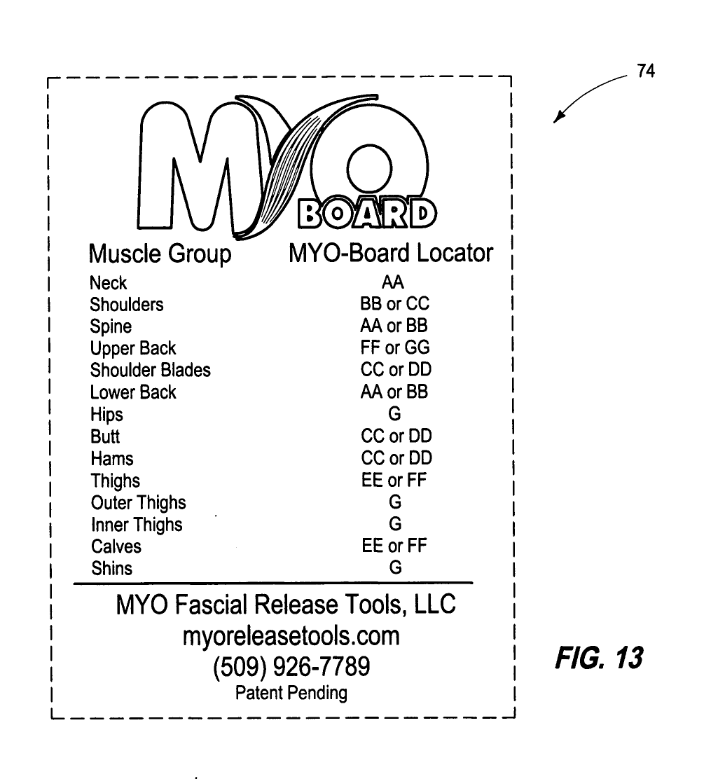

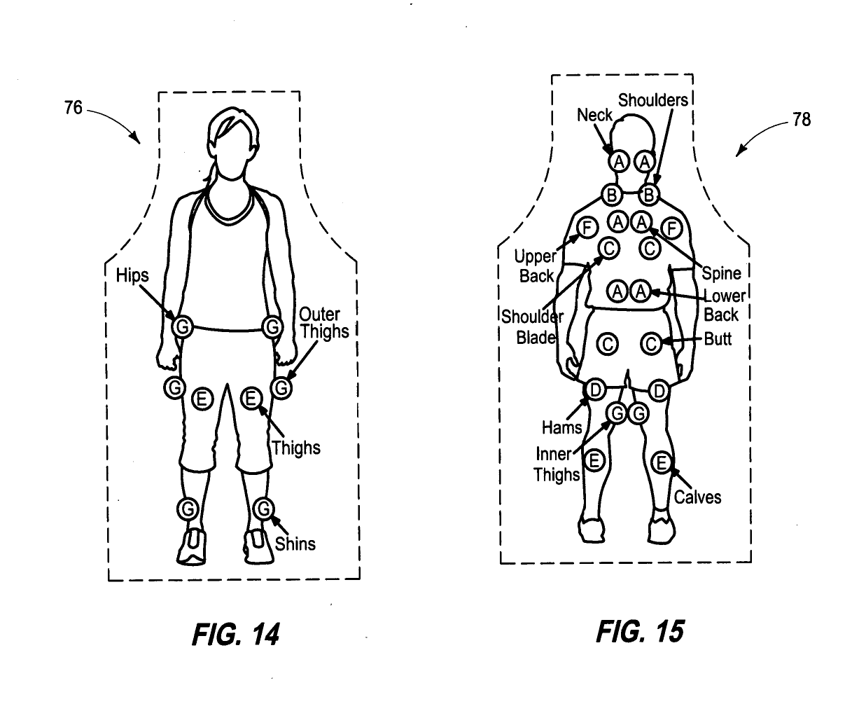

Referring next to FIG. 13, a portion such as an instruction portion 74 can be fixed to assembly 60 and provide a direction for use of the assembly 60. As can be seen, locator direction points such as AA, BB, or CC can be used to direct the user as to the alignment of the myoballs within assembly 60. As an example, these points are shown as portions 76 and 78 as depicted in FIGS. 14 and 15. When a user is utilizing the board, they can place the balls in the depicted points and utilize the spacing of those balls by applying transverse pressure. As an example, the user can lay on top of the board and then traverse the board with the body part of therapeutical interest. With pressure from the weight of the user, the free rotation of the balls in the designated openings, the user can receive myotherapy hands free.

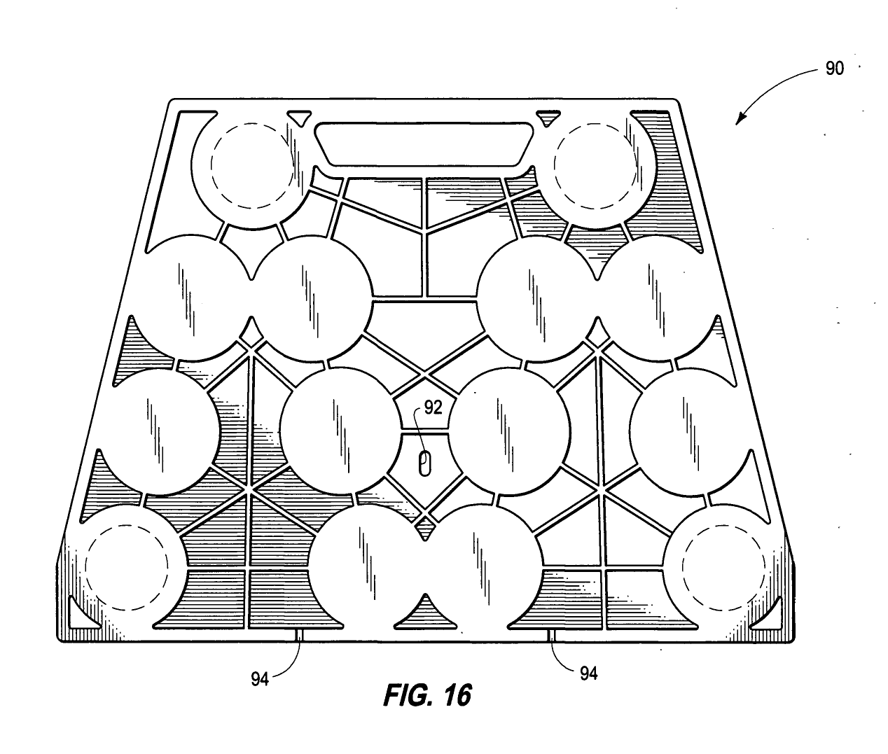

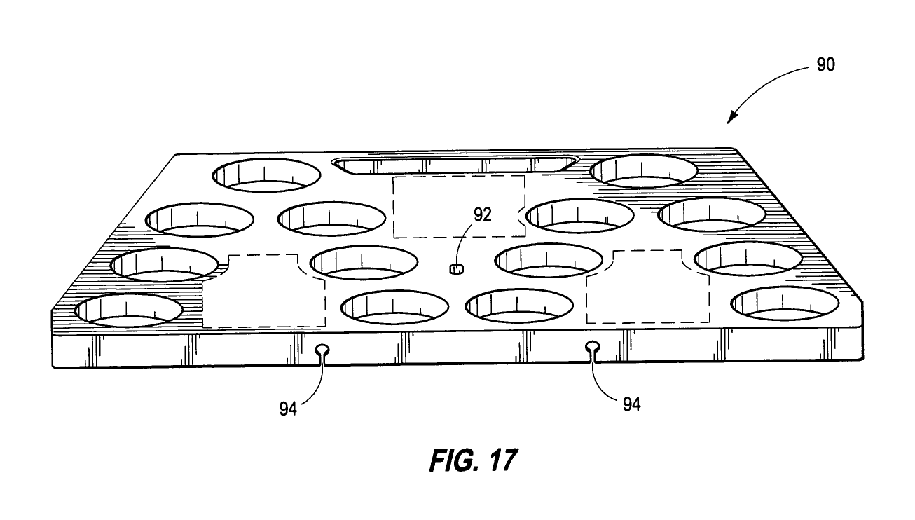

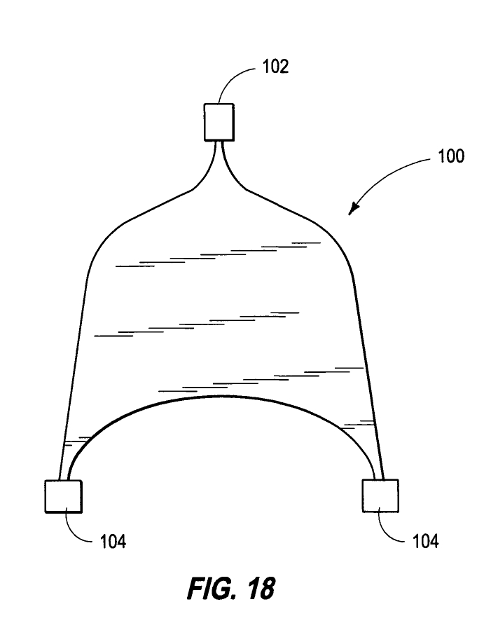

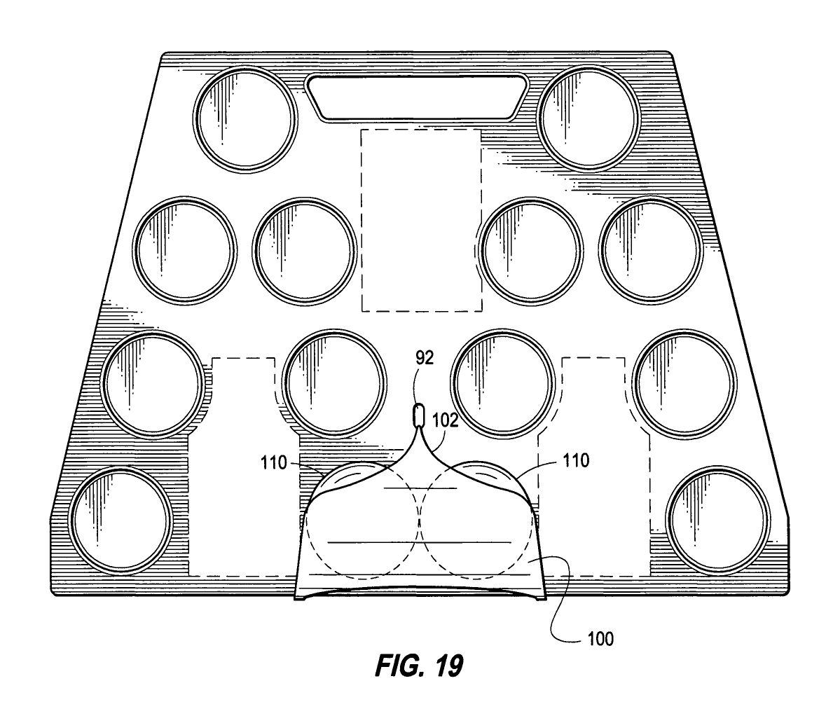

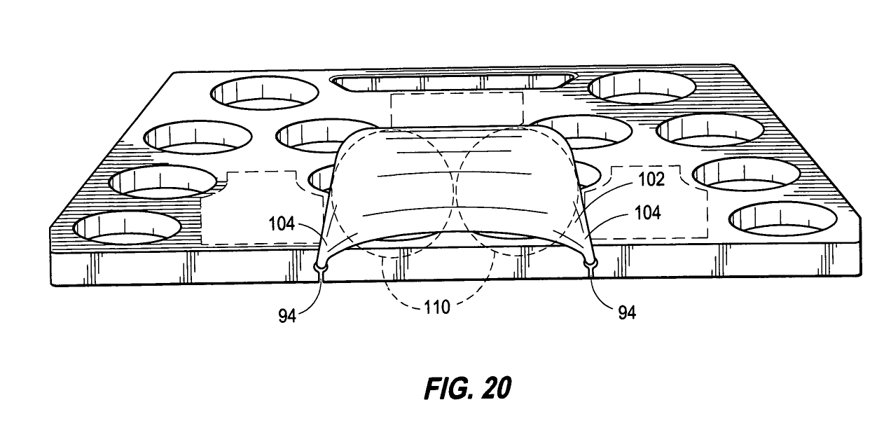

Referring next to FIGS. 16-20, the assembly according to another embodiment is shown, with reference to assembly 90. In accordance with example configurations, assembly 90 can include openings 92 and 94. Referring next to FIG. 17, these openings 92 and 94 are shown in a perspective view, opening 94 having a slot into an opening, and opening 92 being a pass through opening. In accordance with example implementations, and with reference to FIG. 18, a fungible fabric 100 can be constructed of a fungible material such as a biased material, including sponge rubber or a returnable fabric that has connectors 102 and 104 as shown in FIG. 18. In accordance with example configurations, and with reference to FIGS. 19 and 20, fungible fabric 100 can be used to affix myoballs 110 as shown. In accordance with example configurations, connector 102 can be coupled to opening 92, and connectors 104 can be coupled to opening 94.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect.

1. The present disclosure provides physical therapy assemblies that can include boards having specifically aligned openings and designated freely rotating device locations.

2. A method for providing physical therapy that includes providing a board configured to receive myoballs at designated locations for therapy of predefined body parts.
